(19) United States
(12) Patent Application Publication
(10) Pub. No.: US 2022/0343344 A1
(43) Pub. Date: Oct. 27, 2022

(54) SYSTEMS AND METHODS FOR RENEWABLE ENERGY SOURCING

(71) Applicants: Rudra Roy, PASADENA, CA (US); Santanov Chaudhuri, PASADENA, CA (US)

(72) Inventors: Rudra Roy, PASADENA, CA (US); Santanov Chaudhuri, PASADENA, CA (US)

(21) Appl. No.: 17/728,938

(22) Filed: Apr. 25, 2022

Related U.S. Application Data
(60) Provisional application No. 63/179,069, filed on Apr. 23, 2021.

(51) Int. Cl. G06Q 30/02; G06Q 50/06

(52) U.S. Cl. CPC G06Q 30/0201; G06Q 50/06

(57) ABSTRACT

A renewable energy procurement optimizing system for matching a renewable energy consumer with a renewable energy generating supplier comprising: a non-transitory memory storing an executable code, an application program database and an energy information database; and a hardware processor executing the executable code to: receive one or more application parameter input from a renewable energy user; determine, based on the one or more application parameter input and the energy information database an energy match for the renewable energy generating supplier; and generate an output associated with an optimal match for the renewable energy generating supplier, wherein the output utilizes a dynamic model for maximization.

### CROSS-REFERENCE TO RELATED APPLICATIONS

This application incorporates by reference and claims the benefit of priority to U.S. Provisional Application 63/179,069 filed on Apr. 23, 2021.

### BACKGROUND OF THE DISCLOSURE

### Field of the Invention

The present invention relates generally to systems and methods for a renewable energy optimizing systems and particularly to systems and methods for a renewable energy procurement optimization.

A renewable energy consumer can have a variety of parameters to take into account when deciding to acquire a new project from an energy generating supplier. Similarly, an energy generating supplier can have a variety of interests and parameters to take into account when generating a purchase agreement for one or more renewable energy consumers. As a result of the unique metrics and goals for both energy consumers and buyers, it is difficult to determine optimal matching for specific energy development projects, suppliers, and developers.

Moreover, due to the complexity of finding the appropriate renewable energy provider for the appropriate renewable energy consumer, it is time consuming and difficult for project developers to ascertain how to price projects, what locations are suitable for development, and how best to develop a project, based on bids from energy buyers.

Relying merely on historical price data does not provide the most suitable information to aid in deciding which energy projects to pursue, much less creating purchase agreements. Yet it is not feasible to currently take into account real-time energy data when drafting purchase agreements for multiple parties and/or projects. Further, each contract needs to be customized for the specific parties and project, which increases the time and cost.

Accordingly, there is a need for a system for matching a renewable energy consumer with a renewable energy generating supplier and providing an optimized purchase agreement between the parties.

### SUMMARY OF THE DISCLOSURE

The present disclosure is directed to systems and methods for renewable energy procurement, and a system for optimizing the matching of a renewable energy consumer with a renewable energy generating supplier comprising a non-transitory memory storing an executable code, an application program database and an energy information database; and a hardware processor executing the executable code to: receive one or more application parameter input from a renewable energy user; determine, based on the one or more application parameter input and the energy information database an energy match for the renewable energy generating supplier; and generate an output associated with an optimal match for the renewable energy generating supplier, wherein the output utilizes a dynamic model for maximization.

In one aspect, the present disclosure is embodied as a system and a method for matching a renewable energy consumer with renewable energy generating station(s) for the purchase of renewable energy, and/or renewable energy credits. Characteristic information about a plurality of renewable energy generating stations in development and/or operation is received from renewable energy generators, and a plurality of user information, selection criteria and user characteristic information is received from the renewable energy consumer. A request for pricing for the purchase of renewable energy and/or credits is received from the consumer. One or more of the renewable energy generating stations are automatically identified as candidate renewable energy generating station(s) for the consumer based on the selection criteria, the quantity of renewable energy and/or credits, delivery point for renewable energy, and user characteristic information. Information about the renewable energy generator, pricing, volume, shape, term, and delivery of renewable energy and/or credits is provided to the consumer, and/or the information about the consumer and its user characteristic is provided to the identified renewable energy generator(s). The request for renewable energy and credits may be a request for supply at a future date. Multiple renewable energy consumers may be matched to a candidate renewable energy generating station, and multiple renewable energy generating stations may also be matched to a candidate consumer.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims The foregoing and other features and advantages of the present invention will be apparent from the following more particular description of the preferred embodiments of the invention, as illustrated in the accompanying drawings.

Before explaining the various embodiments of the invention in detail, it is to be understood that the invention is not limited in its application to the details of construction and to the arrangements of the components set forth in the following description or illustrated in the drawings. Rather, the invention is capable of other embodiments and of being practiced and carried out in various ways. Also, it is to be understood that the terminology employed herein is for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be made to the accompanying drawings and descriptive matter in which there are illustrated preferred embodiments of the invention.

Various objects, features, aspects and advantages of the present embodiment will become more apparent from the following detailed description of embodiments of the embodiment, along with the accompanying drawings in which like numerals represent like components.

### BRIEF DESCRIPTION OF THE DRAWINGS

The accompanying drawings, which are incorporated in and constitute part of this specification, illustrate embodiments of the disclosure and together with the description, serve to explain the principles of the disclosed embodiments.

FIG. 1 is a schematic diagram illustrating a renewable energy generating system according to some embodiments of the present disclosure.

FIG. 2 is a schematic block diagram illustrating a renewable energy generating station matching system according to some embodiments of the present disclosure.

FIG. 3 is a schematic block diagram illustrating an application program database according to some embodiments of the present disclosure.

FIG. 4 is a schematic block diagram illustrating an energy information database according to some embodiments of the present disclosure.

FIG. 5 is a schematic block diagram illustrating an application parameter input type according to some embodiments of the present disclosure.

FIG. 6 is a flow chart illustrating operations for matching a renewable energy consumer with renewable energy generating station(s) for the sourcing of renewable energy, and/or renewable energy credits according to further embodiments of the present invention.

FIG. 7 is a flow chart illustrating operations for matching a renewable energy consumer with renewable energy generating station(s) for the sourcing of renewable energy, and/or renewable energy credits according to further embodiments of the present invention.

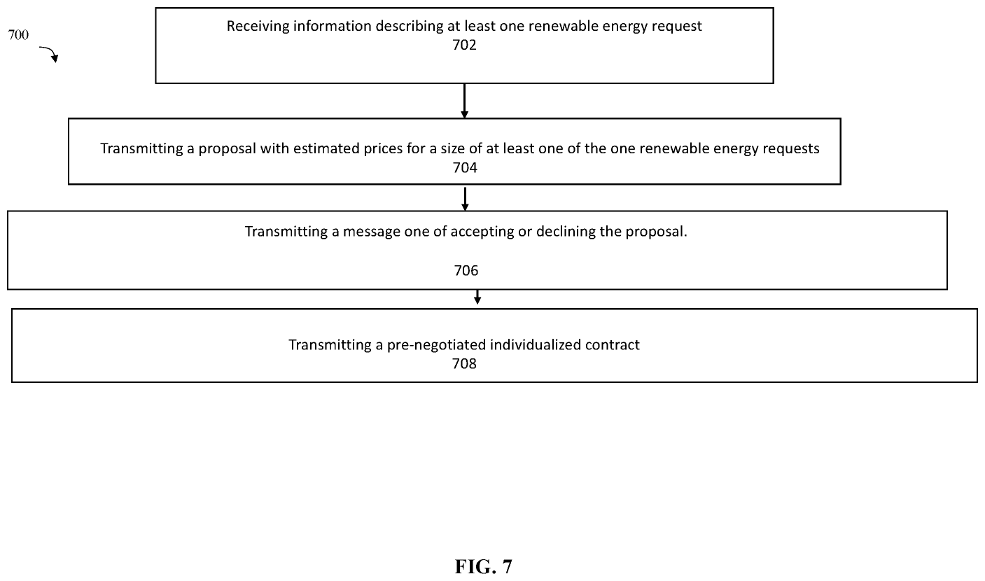

FIG. 8 shows a block diagram of an embodiment of a computer system suitable for use with the disclosed inventions.

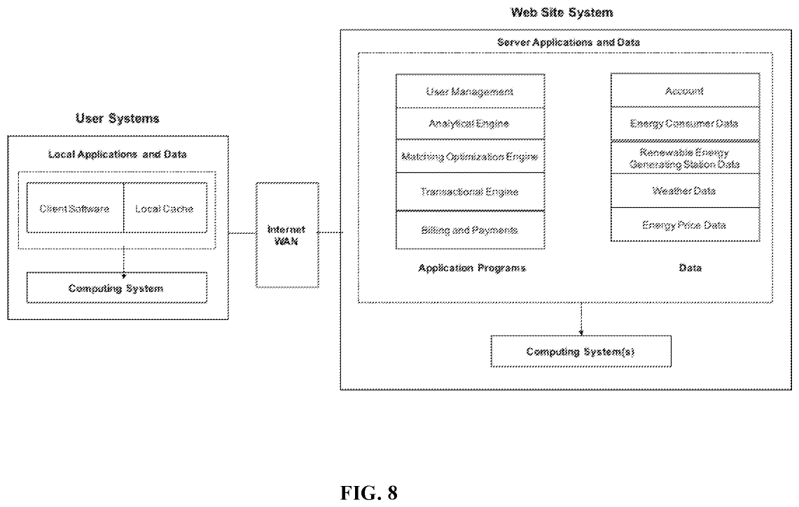

FIG. 9 shows a block diagram of an embodiment of a computer system suitable for use with the disclosed inventions.

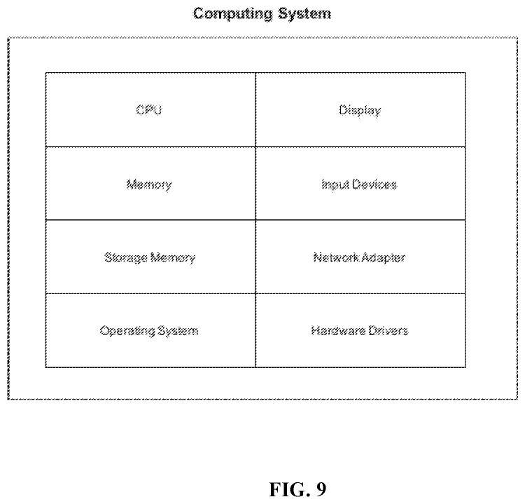

FIG. 10 is a flow chart illustrating operations for matching a renewable energy consumer with renewable energy generating station(s) for the sourcing of renewable energy, and/or renewable energy credits according to some embodiments of the present invention.

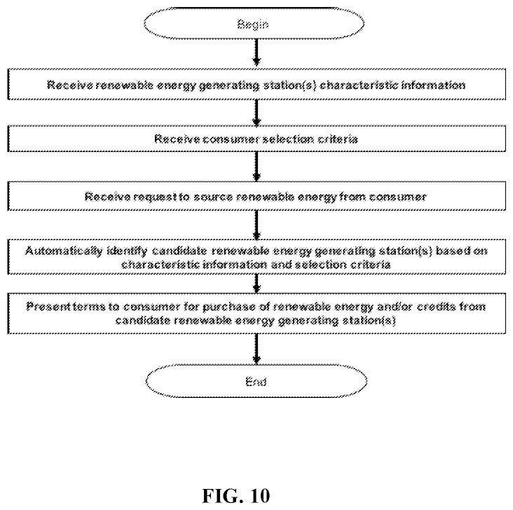

FIG. 11 is a flow chart illustrating operations for matching a renewable energy consumer with renewable energy generating station(s) for the sourcing of renewable energy, and/or renewable energy credits according to other embodiments of the present invention.

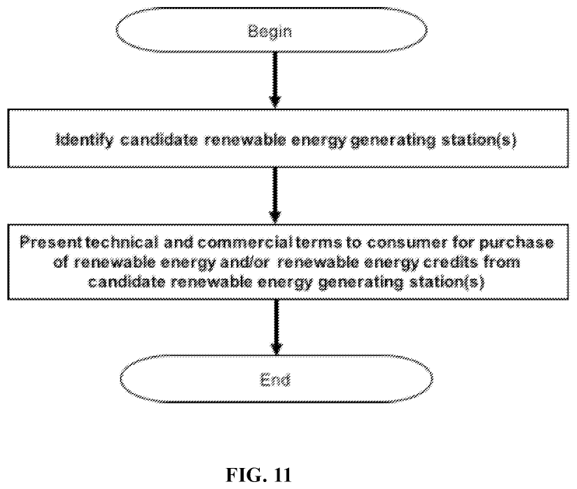

FIG. 12 is a flow chart illustrating operations for matching a renewable energy consumer with renewable energy generating station(s) for the sourcing of renewable energy, and/or renewable energy credits according to further embodiments of the present invention.

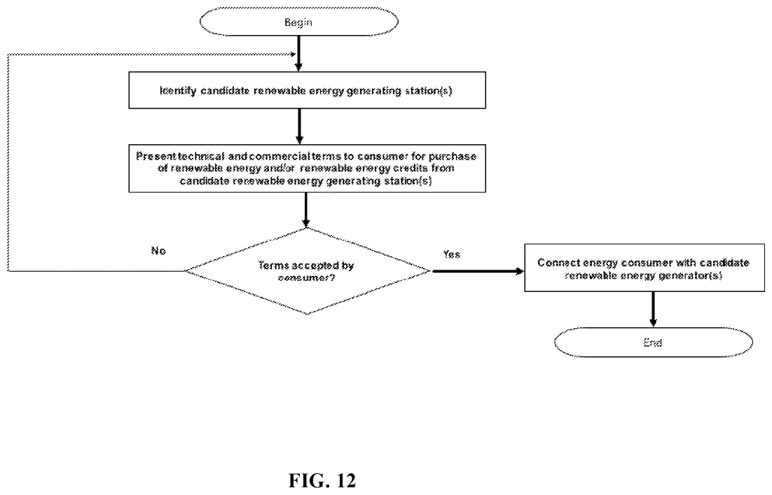

FIG. 13 is a flow chart illustrating operations for matching a renewable energy consumer with renewable energy generating station(s) for the sourcing of renewable energy, and/or renewable energy credits according to further embodiments of the present invention.

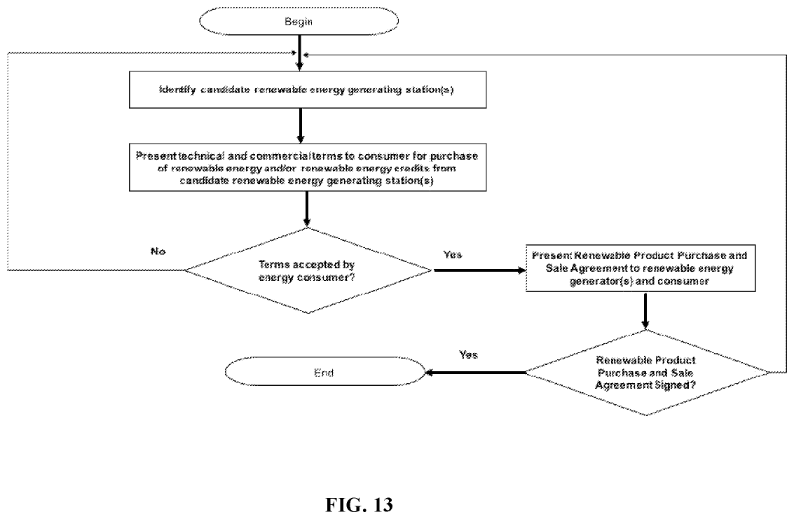

FIG. 14 is a flow chart illustrating operations for matching a renewable energy consumer with renewable energy generating station(s) for the sourcing of renewable energy, and/or renewable energy credits according to further embodiments of the present invention.

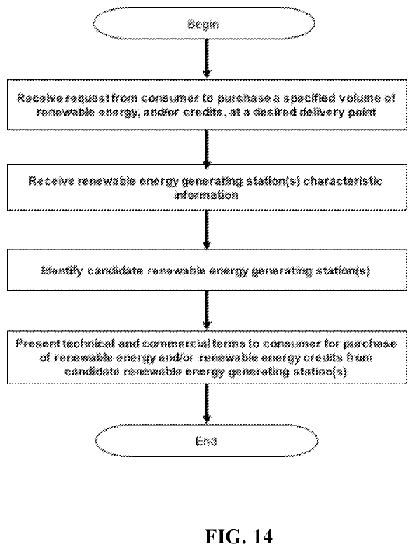

FIG. 15 is a flow chart illustrating operations for matching a renewable energy consumer with renewable energy generating station(s) for the sourcing of renewable energy, and/or renewable energy credits according to further embodiments of the present invention.

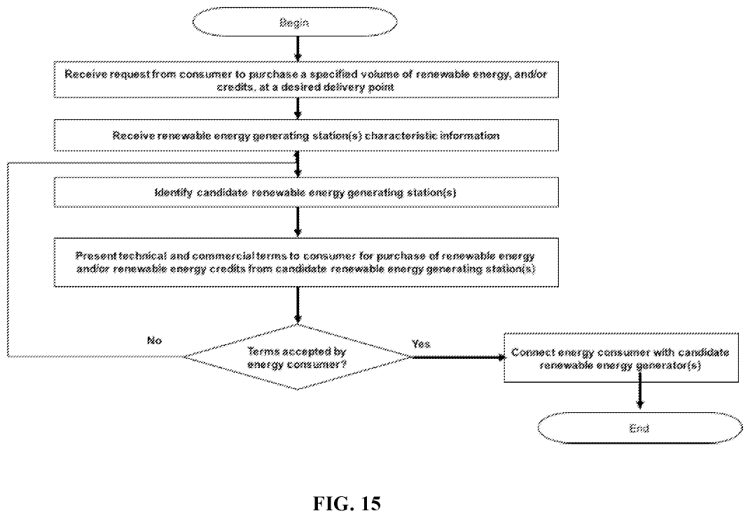

FIG. 16 is a flow chart illustrating operations for matching a renewable energy consumer with renewable energy generating station(s) for the sourcing of renewable energy, and/or renewable energy credits according to further embodiments of the present invention.

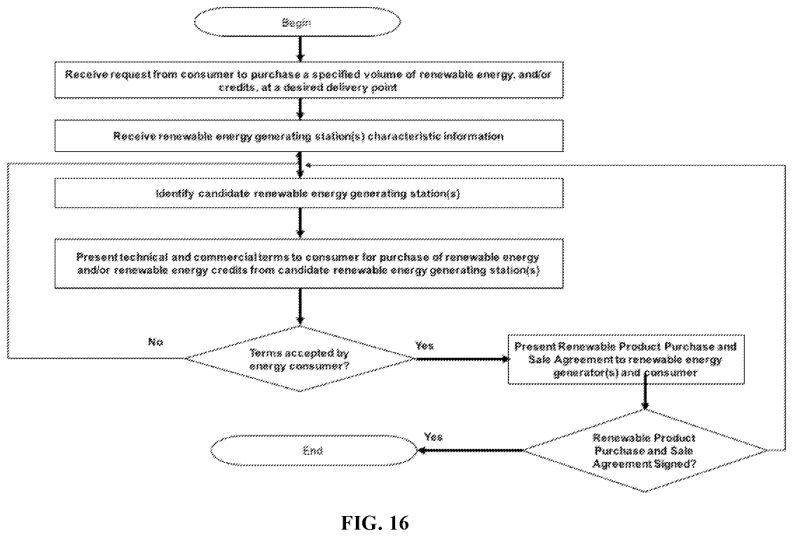

FIG. 17 is a flow chart illustrating operations for matching a renewable energy consumer with renewable energy generating station(s) for the sourcing of renewable energy, and/or renewable energy credits according to further embodiments of the present invention.

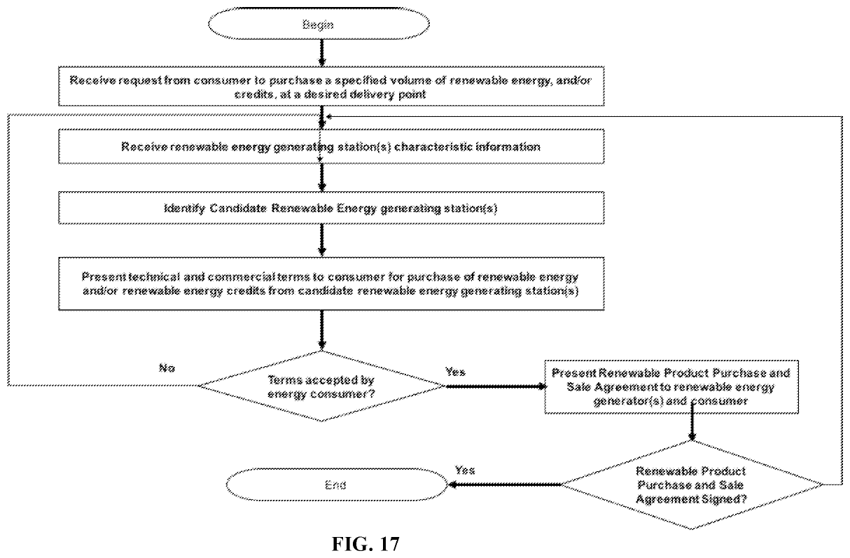

FIG. 18 is a flow chart illustrating operations for matching a renewable energy consumer with renewable energy generating station(s) for the sourcing of renewable energy, and/or renewable energy credits according to further embodiments of the present invention.

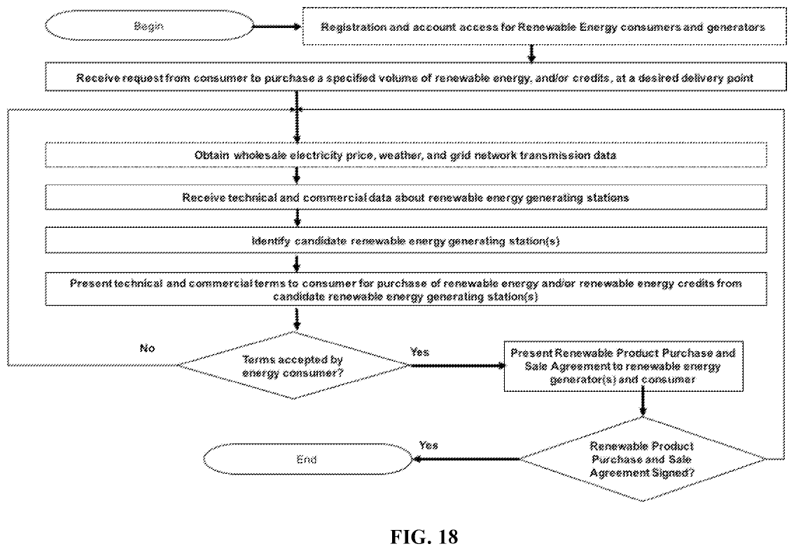

The same elements or parts throughout the figures of the drawings are designated by the same reference characters, while equivalent elements bear a prime designation.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale and are not intended to correspond to actual relative dimensions.

In one embodiment, the present disclosure is embodied as a renewable energy procurement optimizing system for matching a renewable energy consumer with a renewable energy generating supplier comprising: a non-transitory memory storing an executable code, an application program database and an energy information database; and a hardware processor executing the executable code to: receive one or more application parameter input from a renewable energy user; determine, based on the one or more application parameter input and the energy information database an energy match for the renewable energy generating supplier; and generate an output associated with an optimal match for the renewable energy generating supplier, wherein the output utilizes a dynamic model for maximization.

In one embodiment, the executable code is adapted to further generate a pre-negotiated individualized contract including a subscription contract and purchase agreement contract once a selection for the match for the renewable energy generating supplier is received.

In some embodiments, the application program database comprises a user being: a user management, an analytical engine, a matching optimization engine, a transactional engine, a risk assessment engine, a billing engine and/or a payment engine.

In one embodiment according to the present disclosure, the renewable energy procurement optimizing system includes an energy information database comprising: an energy consumer data, a renewable energy generating station data, a weather data, an energy pricing data, a renewable energy shape data, a renewable energy landscape data, an energy regulatory landscape data, an energy transmission, basis, a delivery an energy risk assessment data, a future risk assessment, and/or a renewable energy geographical data.

In other embodiments, the renewable energy procurement optimizing system includes application parameter input being an energy load quantity, an energy pricing, a location, an energy generator, an energy type, an energy volume, an energy output, a timeline for delivery of energy, a regulated energy market, a deregulated energy market, a shape of energy, a direct Power Purchase Agreement, a subscription purchase agreement, and/or a clean energy commitment level.

In one particular embodiment according the present disclosure, the energy generating supplier can be a renewable energy generating station in development, a renewable energy generating station in operation, a future renewable energy generating station, and/or an energy generating station in future planned development.

In one embodiment, the user of present disclosure can be a renewable energy consumer, a renewable energy generating supplier, a renewable energy developer, a renewable energy application builder, an equipment manufacturer, a renewable energy contractor, a utility provider, a renewable energy retailer, and/or renewable energy investor.

In other embodiments, the user is the renewable energy consumer and the renewable energy optimizing system receives the one or more application parameter input, the system triages a plurality of renewable energy generating supplier matches and generates an output associated with an optimal match for the renewable energy generating supplier based on the one or more application parameter input.

In one embodiment, the user can be a renewable energy generating supplier, a renewable energy developer, a renewable energy application builder, an equipment manufacturer, a renewable energy contractor, a utility provider, and a renewable energy investor, the system utilizes a dynamic model for maximization and outputs to said user one or more suggestions and an intel based on the renewable energy consumer input thereby allowing the user to make real time adjustments to a proposal for renewable energy maximization.

In one particular embodiment, the system generates an alert for an optimal match for the renewable energy generating supplier and in other embodiments, the system is further adapted to receive a renewable energy request for a supply at a future date.

The renewable energy procurement optimizing system of the present disclosure can also have an output associated with an optimal match can be a renewable energy consumer matched to a candidate renewable energy generating station, and a plurality of renewable energy generating stations matched to a candidate renewable energy consumer.

The present disclosure can also be embodied as a method for use with a system including a hardware processor and a non-transitory memory, the method comprising the steps of a) receiving, by the hardware processor, one or more application parameter input from a renewable energy user; b) determining, by the hardware processor, based on the one or more application parameter input and an energy information database an energy match for a renewable energy generating supplier; c) generating, using the hardware processor, an output associated with an optimal match for the renewable energy generating supplier utilizing a dynamic model for maximization; and d) transmitting, using the hardware processor, one or more bids based on the one or more application parameter input and the energy information database an energy match for the renewable energy generating supplier.

The method of the present disclosure can also include a client computer and include the steps of: a) receiving, using the hardware processor, information describing at least one renewable energy request; b) transmitting, using the hardware processor, a proposal with estimated prices for a size of at least one of the one renewable energy requests; and d) transmitting, using the hardware processor, a message one of accepting or declining the proposal.

In one embodiment of the present disclosure, the method further includes the steps of transmitting, using the hardware processor, a pre-negotiated individualized contract.

The present disclosure aims to lower the cost of energy and is an end to end digital clean energy platform encompassing solar+storage, (wind) development (site/equipment analysis), estimation, PPA origination, and solar+storage (& later, wind) procurement via structured vPPAs, physical PPAs or other clean energy mechanisms (like RECs) and in the future, pre-negotiated contracts.

In one embodiment, the system and method of the present disclosure allows energy buyers to see developer offers which are continuously updated, compare values of Net Present Value, have access to custom offers, get pre-negotiated templated contracts and PPAs (power purchase agreements), see unique metrics and goals for buyers and energy, track impact goals. Here, user sets a clean energy commitment level and see where it stacks up to the IPCC target and have the ability to exchange energy credits with customers and suppliers.

In an alternative embodiment of the present disclosure, project developers have access to a vast marketplace of buyers, can receive intel on how to price, where to develop and how to develop (enlarge development, location, etc.) based on bids and searches from buyers, have access to custom offers, access to pre-negotiated templated contracts and PPAs power purchase agreements, and can access performance monitoring which provides instant access to near real-time data on a buyers' entire PPA portfolio, giving managers the tools they need to meet goals, maintain budgets, and maximize their renewable energy investments.

In some embodiments, the current system and method allows for higher returns with less risk and allows users to triage projects, reduce costs, originate PPAs, accelerate collaboration, optimize LCOE, and/or manage portfolios. Here application builders can build applications through the HST API framework to seamlessly get solar energy data, payback time, LCOE, IRR, and more.

In some embodiments, solar developers can, thanks to the present disclosure, streamline siting decisions, originate PPAs with corporate buyers, evaluate more projects with platform, triage projects in their pipeline, and/or accelerate RFP response times.

A number of program modules and data files may be stored in system memory, including operating system. While executing on processing unit, programming modules (e.g. program module) may perform processes including, for example, one or more of the stages of a process. The aforementioned processes are examples, and processing unit may perform other processes. Other programming modules that may be used in accordance with embodiments of the present invention may include electronic mail and contacts applications, word processing applications, spreadsheet applications, database applications, slide presentation applications, drawing or computer-aided application programs, etc.

In one embodiment, server may utilize a machine learning model or a rule-based model in order to generate predictions associated with pricing and risk management configured to be utilized by system 100. For example, if the model is a machine-learned model, then one or more machine learning techniques are used to “learn” weights of different features, which weights are then utilized by server to generate one or more estimates associated with a renewable energy match.

In one embodiment, the server is configured to generate a classification model generated based on training data utilizing the one or more aforementioned machine learning techniques. Machine learning is the study and construction of algorithms that can learn from, and make predictions on, data. Such algorithms operate by building a model from inputs in order to make data-driven predictions or decisions. Thus, a machine learning technique is used to generate a statistical that is trained based on a history of attribute values associated with data utilized within system 100. The machine-learned model is trained based on multiple attributes (or factors) described herein. In machine learning parlance, such attributes are referred to as “features”. In an embodiment, various feature weights or coefficients are established in order to accurately generate predictions for system 100. To generate and train a machine-learned model, a set of features is specified and training data is generated. In an embodiment, a new machine-learned model is generated regularly, such as every month, week, or other time period. Thus, the new machine-learned model may replace a previous machine-learned model. Newly acquired or changed training data may be used to update the model.

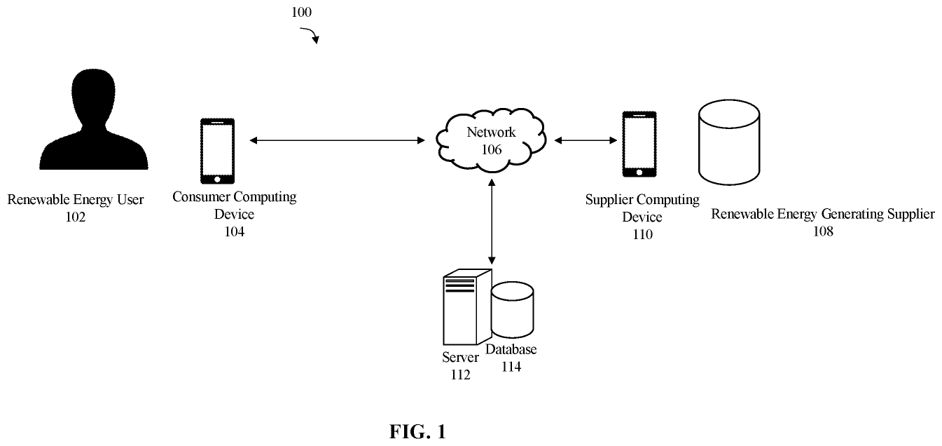

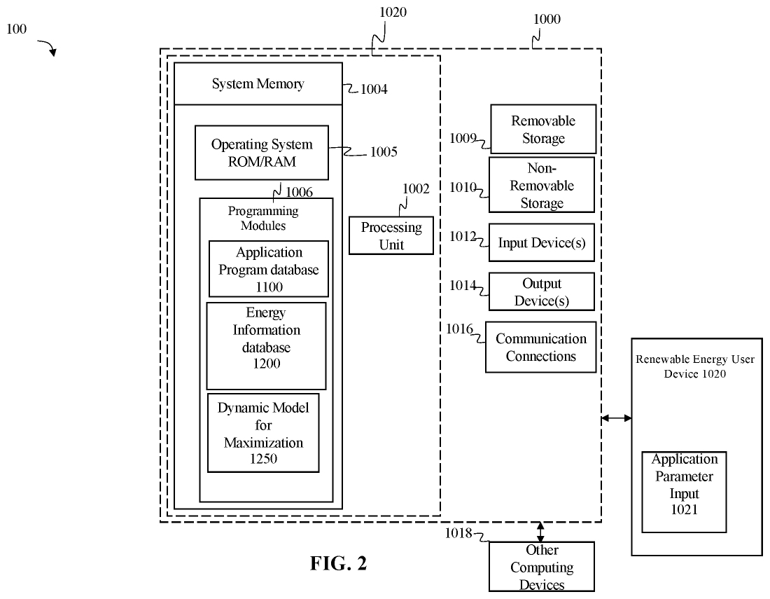

Referring now to FIGS. 1 and 2, there is presented a renewable energy procurement optimizing system 100 for matching a renewable energy user 102 with a renewable energy generating supplier 108. Here the system includes a non-transitory memory 1004 storing an executable code 1006, an application program database 1100 and an energy information database 1200; and a hardware processor 1002. The executable code is adapted to receive one or more application parameter input 1021 from a renewable energy user 102; determine, based on the one or more application parameter input 1021 and the energy information database 1200 an energy match for the renewable energy generating supplier; and generate an output associated with an optimal match for the renewable energy generating supplier, where the output utilizes a dynamic model for maximization 1250.

In some embodiments, the renewable energy procurement optimizing system 100 has can further generate a pre-negotiated individualized contract including a subscription contract and purchase agreement contract once a selection for the match for the renewable energy generating supplier is received.

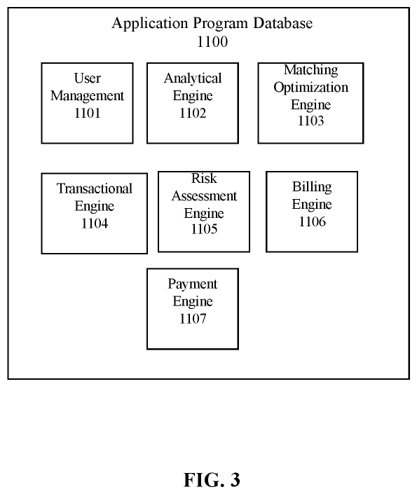

In other embodiments as illustrated in FIG. 3, the renewable energy procurement optimizing system 100 includes the application program database 1100 which in turn can comprises a user management 1101, an analytical engine 1102, a matching optimization engine 1103, a transactional engine 1104, a risk assessment engine 1105, a billing engine 1106 and/or a payment engine 1107 or similar relevant data.

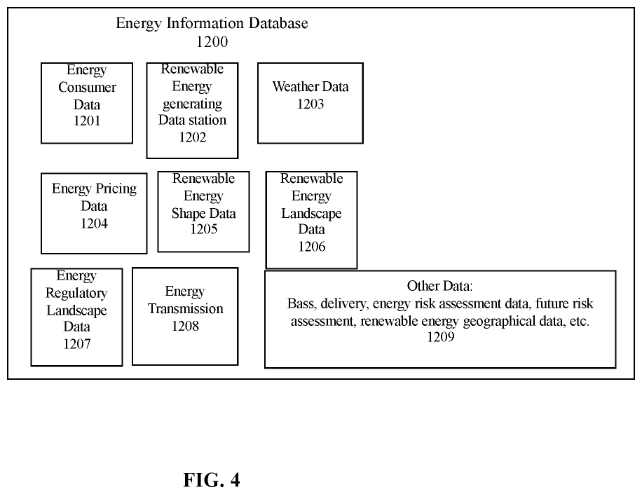

In other embodiments as shown in FIG. 4, the renewable energy procurement optimizing system 100 includes an energy information database 1200 which in turn can comprise an energy consumer data 1201, a renewable energy generating station data 1202, a weather data 1203, an energy pricing data 1204, a renewable energy shape data 1205, a renewable energy landscape data 1206, an energy regulatory landscape data 1207, an energy transmission 1208, or other: 1209 such as an energy basis, a delivery, an energy risk assessment data, a future risk assessment, and/or a renewable energy geographical data.

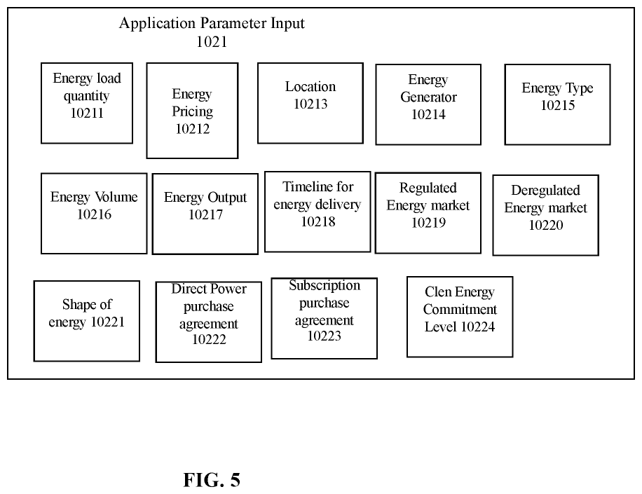

In other embodiments as the one depicted in FIG. 5, the application parameter input 1021 can be an energy load quantity 10211, an energy pricing 10212, a location 10213, an energy generator 10214, an energy type 10215, an energy volume 10216, an energy output 10217, a timeline for delivery of energy 10218, a regulated energy market 10219, a deregulated energy market 10220, a shape of energy 10221, a direct Power Purchase Agreement 10222, a subscription purchase agreement 10223, and/or a clean energy commitment level 10224. Here, a user can decide on their clean energy commitment level by a certain year and or a certain timeframe and find a supplier that can help them achieve that goal.

In another embodiment, the energy generating supplier can be a renewable energy generating station in development, a renewable energy generating station in operation, a future renewable energy generating station, and/or an energy generating station in future planned development.

In yet another embodiment, the user of the system can be defined as a renewable energy consumer, a renewable energy generating supplier, a renewable energy developer, a renewable energy application builder, an equipment manufacturer, a renewable energy contractor, a utility provider, a renewable energy retailer, and/or a renewable energy investor. Here the system can help match and help optimize for a variety of different types of user.

In another embodiment, when the user is the renewable energy consumer and the renewable energy optimizing system receives the one or more application parameter input, the system triages a plurality of renewable energy generating supplier matches and generates an output associated with an optimal match for the renewable energy generating supplier based on the one or more application parameter input.

In yet another embodiment, when the user is a renewable energy generating supplier, a renewable energy developer, a renewable energy application builder, an equipment manufacturer, a renewable energy contractor, a utility provider, and/or a renewable energy investor, the system utilizes a dynamic model for maximization and outputs to the user one or more suggestions and an intel based on the renewable energy consumer input thereby allowing the user to make real time adjustments to a proposal for renewable energy maximization. In a particular embodiment, the system 100 generates an alert for an optimal match for the renewable energy generating supplier, in other embodiments, the system is further adapted to receive a renewable energy request for a supply at a future date.

In a particular embodiment of the present disclosure, the output associated with an optimal match can be a plurality of renewable energy consumers matched to a candidate renewable energy generating station, and/or a plurality of renewable energy generating stations matched to a candidate renewable energy consumer.

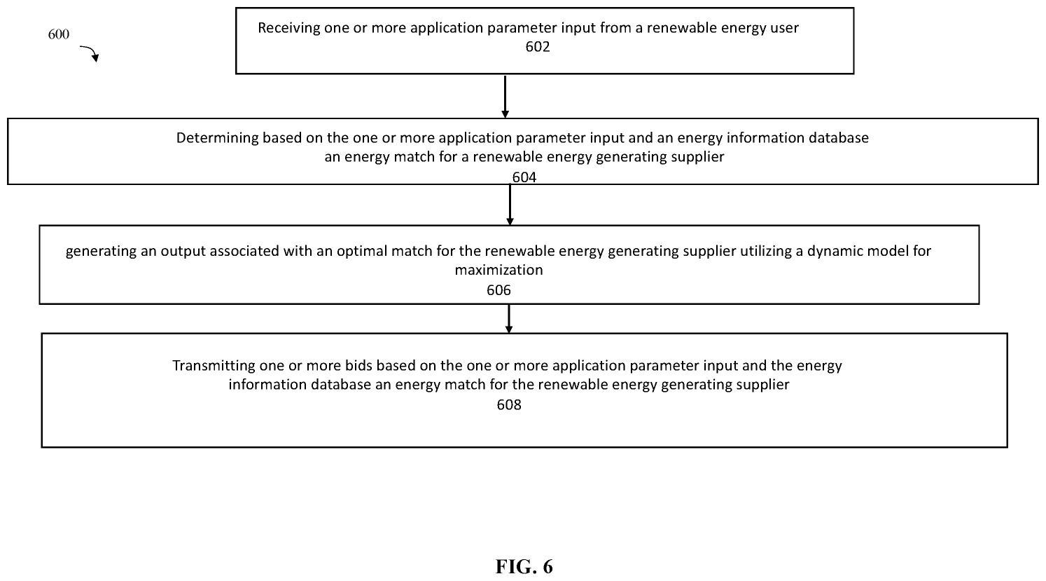

As seen in FIG. 6, the present disclosure can also be embodied in a method for use with a system including a hardware processor and a non-transitory memory 600, the method comprising the steps of a) receiving, by the hardware processor, one or more application parameter input from a renewable energy user 602; b) determining, by the hardware processor, based on the one or more application parameter input and an energy information database an energy match for a renewable energy generating supplier 604; c) generating, using the hardware processor, an output associated with an optimal match for the renewable energy generating supplier utilizing a dynamic model for maximization 606; and d) transmitting, using the hardware processor, one or more bids based on the one or more application parameter input and the energy information database an energy match for the renewable energy generating supplier 608.

In another embodiment of the method, a client computer is included and the method also includes the steps of a) receiving, using the hardware processor, information describing at least one renewable energy request; b) transmitting, using the hardware processor, a proposal with estimated prices for a size of at least one of the one renewable energy requests; and d) transmitting, using the hardware processor, a message one of accepting or declining the proposal. The method can also transmit, using the hardware processor, a pre-negotiated individualized contract.

In other embodiments, the method can also include the steps of providing, using the hardware processor, additional information which can be one of an energy consumer data, a renewable energy generating station data, a weather data, an energy pricing data, a renewable energy shape data, a future energy landscape data, an energy risk assessment data, a future risk assessment, an energy regulatory landscape data, an energy transmission, basis, a contract term risk assessment, and/or a renewable energy geographical data.

In yet another embodiment, the method can also include the steps of a) receiving, using the hardware processor, information describing at least one renewable energy request; b) triaging, using the hardware processor, a plurality of renewable energy generating supplier matches; and c) generating, using the hardware processor, an output associated with an optimal match for the renewable energy generating supplier based on the renewable energy request.

In a particular embodiment, the method can also include the steps of a) receiving, using the hardware processor, information describing at least one renewable energy supplier; b) receiving, using the hardware processor, information describing at least one renewable energy request; c) compiling, using the hardware processor, a plurality of renewable energy intel from the at least one renewable energy request; c) generating, using the hardware processor, a recommendation thereby allowing the renewable energy supplier; and d) receiving, using the hardware processor, real time adjustments to a proposal for renewable energy maximization. The system can also generate, using the hardware processor, an alert for an optimal match for the renewable energy generating supplier.

In yet another embodiment, the method can also include the steps of a) storing training data that comprises a plurality of training instances, each of which includes a plurality of feature values and a label that indicates whether the training instance pertains to the renewable energy match and a renewable energy alert; and b) using one or more machine learning techniques to train a classification model based on the training data.

The present disclosure varies from other systems and methods in that it is not a method of providing power to a load by submitting bids to the coordinator (let alone with a controller.) Here, the coordinator, both for matching and actually for developing the contract with the generating stations. Here, the system can also include templated contract—PPA power stations. These templated include pre-negotiated terms with the suppliers and can include future terms, wholesale level, future power stations, bulk purchase, balancing price v. risk price, risk, power station failure, weather, covered contractually risk assessment, timeline, and risk: location—traffic jams in powerlines, ability to get a permit—wind turbines, delivery of product on time.

In one embodiment, the risk assessment includes weather data consideration, with a view of climate change, generation risk (how much energy is coming off a station/Operation and maintenance, project execution risk (trade war, tariffs.) Another data that is considered in the present method is the shape risk of an energy, here hourly graph of sunshine, wind, and the shape of the line when the actual energy will be hitting for the buyers (energy needs for a period of time) is considered, and the system includes both existing data and future data.

In general, energy suppliers or seller deal with balancing risk. Here the system balances the risk and makes those offers more attractive to an energy user or energy consumer including matching. In most embodiments, a smart contract is used.

The system compiles data based on the combination of project energy prices, energy shapes, locations etc. that are found in the database; further, we have in our method the ability to have the energy sale contract itself either pre-negotiated or pre-templated in the system.

In one embodiment, the pre-negotiated or pre-templated in the system happens when a fee and payment is taken from the buyer and a fee and payment is taken from the seller. The system is also capable of buying pre-negotiated or pre-templated contracts and later selling them to other consumers.

In one embodiment, the system 100 includes an optimizable and or customizable pricing from generators for projects within the bulk power system. This also includes projects and energy supply sources that have not been built yet. The system can also include a plurality of (Distributed Energy Resource) DER demand and DER operators. The system also connects more broadly to energy resources that don't have to be distributed. DER typically is focused around rooftop solar, Electric Vehicles, small wind, and small batteries that are behind the meter, or within the energy users' mini network before it goes out to the utility grid. Here, the system handles all optimization for of any size and can be front of the meter (ie part of the utility grid).

In one embodiment, the method of the present disclosure matches an energy consumer to an energy supplier based on price, energy, project site location etc. The system and method of the present disclosure also allow energy shape optimization, project site optimization, etc, but all of this is well before a project is built so there is no power flowing. A power flow optimization can also happen when grid is receiving the power, battery bank.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general-purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. It is also understood that components of the system may be interchangeable or modular so that the components may be easily changed or supplemented with additional or alternative components.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

From the above description, it is manifest that various techniques can be used for implementing the concepts described in the present application without departing from the scope of those concepts. Moreover, while the concepts have been described with specific reference to certain implementations, a person having ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A renewable energy procurement optimizing system for matching a renewable energy consumer with a renewable energy generating supplier comprising:
a non-transitory memory storing an executable code, an application program database and an energy information database; and
a hardware processor executing the executable code to:
receive one or more application parameter input from a renewable energy user;
determine, based on the one or more application parameter input and the energy information database an energy match for the renewable energy generating supplier; and
generate an output associated with an optimal match for the renewable energy generating supplier, wherein the output utilizes a dynamic model for maximization.

2. The renewable energy procurement optimizing system of claim 1 wherein the hardware processor executing the executable code to further generate a pre-negotiated individualized contract including a subscription contract and purchase agreement contract once a selection for the match for the renewable energy generating supplier is received.

3. The renewable energy procurement optimizing system of claim 1 wherein the application program database comprises at least one of a user management, an analytical engine, a matching optimization engine, a transactional engine, a risk assessment engine, a billing engine and a payment engine.

4. The renewable energy procurement optimizing system of claim 1 wherein the energy information database comprises at least one of an energy consumer data, a renewable energy generating station data, a weather data, an energy pricing data, a renewable energy shape data, a renewable energy landscape data, an energy regulatory landscape data, an energy transmission, basis, a delivery, an energy risk assessment data, a future risk assessment, and a renewable energy geographical data.

5. The renewable energy procurement optimizing system of claim 1 wherein the one or more application parameter input is at least one of an energy load quantity, an energy pricing, a location, an energy generator, an energy type, an energy volume, an energy output, a timeline for delivery of energy, a regulated energy market, a deregulated energy market, a shape of energy, a direct Power Purchase Agreement, a subscription purchase agreement, and a clean energy commitment level.

6. The renewable energy procurement optimizing system of claim 1 wherein the energy generating supplier is at least one of a renewable energy generating station in development, a renewable energy generating station in operation, a future renewable energy generating station, and an energy generating station in future planned development.

7. The renewable energy procurement optimizing system of claim 1 wherein said user is at least one of a renewable energy consumer, a renewable energy generating supplier, a renewable energy developer, a renewable energy application builder, an equipment manufacturer, a renewable energy contractor, a utility provider, a renewable energy retailer, and a renewable energy investor.

8. The renewable energy procurement optimizing system of claim 7 wherein when said user is the renewable energy consumer and the renewable energy optimizing system receives the one or more application parameter input, the system triages a plurality of renewable energy generating supplier matches and generates an output associated with an optimal match for the renewable energy generating supplier based on the one or more application parameter input.

9. The renewable energy procurement optimizing system of claim 7 wherein when said user is at least one of a renewable energy generating supplier, a renewable energy developer, a renewable energy application builder, an equipment manufacturer, a renewable energy contractor, a utility provider, and a renewable energy investor, the system utilizes a dynamic model for maximization and outputs to said user one or more suggestions and an intel based on the renewable energy consumer input thereby allowing the user to make real time adjustments to a proposal for renewable energy maximization.

10. The renewable energy procurement optimizing system of claim 1 wherein the system generates an alert for an optimal match for the renewable energy generating supplier.

11. The renewable energy procurement optimizing system of claim 1 wherein the system is further adapted to receive a renewable energy request for a supply at a future date.

12. The renewable energy procurement optimizing system of claim 1 1 wherein the output associated with an optimal match is at least one of a plurality of renewable energy consumers matched to a candidate renewable energy generating station, and a plurality of renewable energy generating stations matched to a candidate renewable energy consumer.

13. A method for use with a system including a hardware processor and a non-transitory memory, the method comprising:
a) receiving, by the hardware processor, one or more application parameter input from a renewable energy user;
b) determining, by the hardware processor, based on the one or more application parameter input and an energy information database an energy match for a renewable energy generating supplier;
c) generating, using the hardware processor, an output associated with an optimal match for the renewable energy generating supplier utilizing a dynamic model for maximization; and
d) transmitting, using the hardware processor, one or more bids based on the one or more application parameter input and the energy information database an energy match for the renewable energy generating supplier.

14. The method of claim 13 including a client computer and further comprising the steps of:
a) receiving, using the hardware processor, information describing at least one renewable energy request;
b) transmitting, using the hardware processor, a proposal with estimated prices for a size of at least one of the one renewable energy requests; and
d) transmitting, using the hardware processor, a message one of accepting or declining the proposal.

15. The method of claim 14, further comprising:
transmitting, using the hardware processor, a pre-negotiated individualized contract.

16. The method of claim 13, further comprising:
providing, using the hardware processor, additional information comprising at least one of an energy consumer data, a renewable energy generating station data, a weather data, an energy pricing data, a renewable energy shape data, a future energy landscape data, an energy risk assessment data, a future risk assessment, an energy regulatory landscape data, an energy transmission, basis, a contract term risk assessment, and a renewable energy geographical data.

17. The method of claim 13, further comprising:
a) receiving, using the hardware processor, information describing at least one renewable energy request;
b) triaging, using the hardware processor, a plurality of renewable energy generating supplier matches; and
c) generating, using the hardware processor, an output associated with an optimal match for the renewable energy generating supplier based on the renewable energy request.

18. The method of claim 13, further comprising:
a) receiving, using the hardware processor, information describing at least one renewable energy supplier;
b) receiving, using the hardware processor, information describing at least one renewable energy request;
c) compiling, using the hardware processor, a plurality of renewable energy intel from the at least one renewable energy request;
c) generating, using the hardware processor, a recommendation thereby allowing the renewable energy supplier; and
d) receiving, using the hardware processor, real time adjustments to a proposal for renewable energy maximization.

19. The method of claim 13, further comprising: generating, using the hardware processor, an alert for an optimal match for the renewable energy generating supplier.

20. The method of claim 13, further comprising the steps of:
a) storing training data that comprises a plurality of training instances, each of which includes a plurality of feature values and a label that indicates whether the training instance pertains to the renewable energy match and a renewable energy alert; and
b) using one or more machine learning techniques to train a classification model based on the training data.
